(19) United States
(12) Patent Application Publication
(10) Pub. No.: US 2026/0252465 A1
(43) Pub. Date: Aug. 27, 2026

(54) TRACE-BASED ANALYSIS AND MEMORY MIGRATION

(71) Applicant: International Business Machines Corporation, Armonk, NY (US)

(72) Inventors: Ting Wang, Shanghai (CN); Zheng Chen, Shanghai (CN); Kai Luo, Shenzhen (CN); Chaofan Qiu, Shanghai (CN); Li Rong Yi, Shanghai (CN); Yangming Wang, SHANGHAI (CN); Si Yuan Zhang, Shanghai (CN)

(21) Appl. No.: 19/064,881

(22) Filed: Feb. 27, 2025

(51) Int. Cl. G06F 11/34

(52) U.S. Cl. CPC G06F 11/3471; G06F 11/3485

(57) ABSTRACT

A present invention embodiment provides trace-base analysis and memory migration. A trace is performed on a process that is executing one or more preconfigured tasks to collect trace data comprising memory access addresses of the process and function calls of the process. The trace data is analyzed to identify one or more metadata memory regions based on frequent memory accesses and a content memory region based on infrequent memory accesses during the trace. It is determined that a portion of content addresses of the content memory region can be migrated to a remote memory without disrupting execution of the process. The portion of content addresses is migrated to the remote memory. The process is patched to insert remote logic that redirects access operations to the portion of the content addresses to the migrated portion of content addresses in the remote memory. The process is executed.

### BACKGROUND

### 1. Technical Field

Present invention embodiments relate to data processing systems, and more specifically, to systems that share physical memory at a rack level.

### 2. Discussion of the Related Art

Memory inception refers to a technology that enables multiple systems (e.g., nodes) to share and pool their physical memory resources at a rack level. Memory inception techniques can present physically-dispersed memory across different machines as if there is a single, larger unified memory space, so that applications on one node can allocate or access memory that resides on another node. Applications such as in-memory databases, whose memory requirements can exceed the capacity of a single node, benefit from memory inception techniques. However, conventional approaches requires manual configuration of an application in order to utilize memory inception.

### SUMMARY

According to one embodiment of the present invention, a system is provided for remote memory migration using trace-based data classification. A trace is performed on a process that is executing one or more preconfigured tasks to collect trace data comprising memory access addresses of the process and function calls of the process. The trace data is analyzed to identify one or more metadata memory regions based on frequent memory accesses and a content memory region based on infrequent memory accesses during the trace. It is determined that a portion of content addresses of the content memory region can be migrated to a remote memory without disrupting execution of the process. The portion of content addresses is migrated to the remote memory. The process is patched to insert remote logic that redirects access operations to the portion of the content addresses to the migrated portion of content addresses in the remote memory. The process is executed.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of application code according to an embodiment of the present invention.

FIG. 3A-3C are graphs of memory-access instructions/memory-address patterns according to an embodiment of the present invention.

FIG. 4 is a flowchart of a method for performing a trace-based analysis and memory migration according to an embodiment of the present invention.

FIG. 5 is a flowchart of a method for identifying a content region according to an embodiment of the present invention.

FIG. 6 is a flowchart of a method for migrating a content region according to an embodiment of the present invention.

FIG. 7A is a block diagram of a processing environment before migration of a content region according to an embodiment of the present invention.

FIG. 7B is a block diagram of a processing environment after migration of a content region according to an embodiment of the present invention.

### DETAILED DESCRIPTION

A present invention embodiment relates to data processing systems, and more specifically, to systems that share physical memory at a rack-level. Memory inception, which may also be referred to as memory pooling, enables sharing of physical memories at a rack level. Memory inception provides an operating system-level application programming interface (API) for applications to allocate physical memory pages on other nodes in a pool. However, conventional approaches requires manual configuration of an application in order to utilize memory inception techniques. Without knowledge of an application's memory usage, including which memory regions are frequently accessed, conventional approaches may allocate frequently-accessed memory regions to a remote node, introducing delays when those regions are accessed.

The embodiments presented herein address this problem by automating the analysis of application memory usage in order to determine which memory regions should be kept local and which memory regions may be allocated to other nodes. In particular, a trace of a process is performed while the process executes preconfigured tasks. The trace data is then analyzed to determine the structure of memory regions based on memory access profiles. Memory regions that are repeatedly accessed are identified as “metadata” regions, whereas an infrequently-accessed region may be identified as a “content” region, which represents the underlying data rather than metadata, pointers, etc., and which can be migrated. The process may be patched to insert forwarding logic to cause the process to access the remote memory to which the content is migrated.

Thus, present embodiments improve the technical field of computing by improving the performance and efficiency of processes that use large amounts of memory, such as in-memory database applications. Present invention embodiments provide several practical applications, including reducing memory access times, enabling larger amounts of data (e.g., in-memory database data) to be processed, and improving load-balancing of memory operations across nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

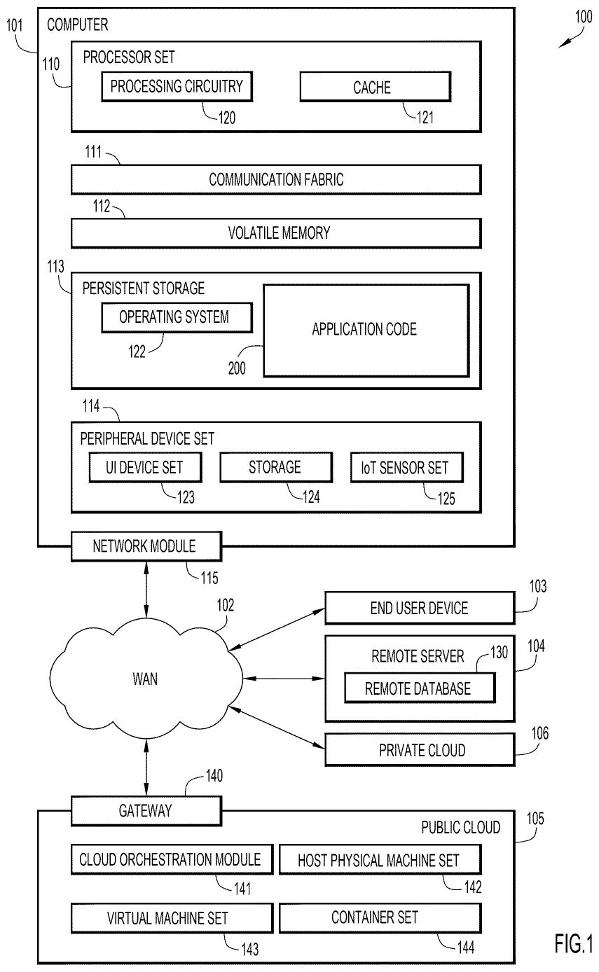

Referring to FIG. 1, computing environment 100 contains an example of an environment for the execution of at least some of the computer code involved in performing the inventive methods, such as application code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

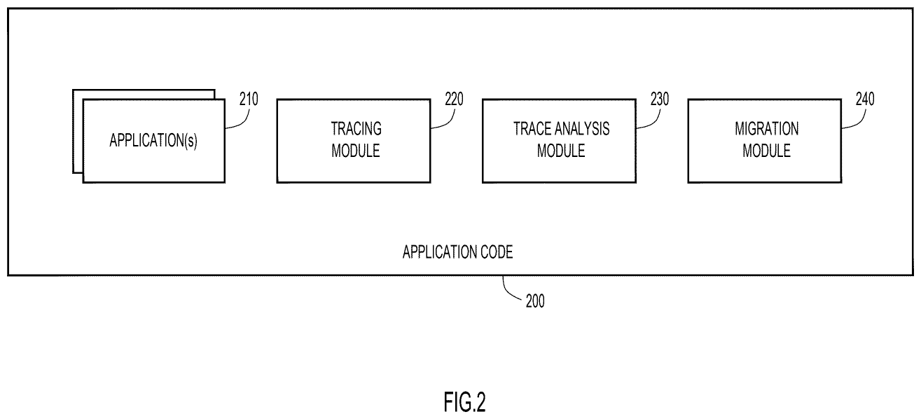

A block diagram of application code 200 according to an embodiment of the present invention is illustrated in FIG. 2. Specifically, application code 200 one or more applications 210, a tracing module 220, a trace analysis module 230, and a migration module 240. Application(s) 210, tracing module 220, trace analysis module 230, and/or migration module 240 may include one or more modules or units to perform various functions of present invention embodiments described herein. Application(s) 210, tracing module 220, trace analysis module 230, and/or migration module 240 may be implemented by any combination of any quantity of software and/or hardware modules or units, and may reside within volatile memory 112 of computer 101 for execution by a processor, such as processor set 110.

Application(s) 210 may include any software, such as in-memory database applications, cloud applications, and the like. For example, application(s) 210 may include Remote Dictionary Server (Redis), High-performance Analytic Appliance (HANA), and the like. Application(s) 210 may perform operations in which a large amount of memory is required (e.g., an amount of memory exceeding a particular node's local memory). Application(s) 210 may not be natively configured to utilize memory inception.

Tracing module 220 may perform a trace and collect trace data regarding application(s) 210. During runtime of a process (e.g., any application(s) 210), tracing module 220 updates the process to collect trace data that include memory address accesses and function calls in time sequence. Tracing module 220 provides input data to the process being traced that includes different preconfigured tasks, thus enabling memory access patterns to be determined. The preconfigured tasks may be selected such that a process executes each function call of the process, enabling memory access patterns to be exhaustively obtained.

Thus, for each memory access instruction being traced, a memory access address can be determined. Tracing module 220 may utilize an application programming interface (API) to attach to the process being traced, and allocates writable and executable memory. In some embodiments, tracing module 220 inserts code (e.g., a trampoline) into the process that intercepts or redirects calls to the trace function first, enabling the trace data to be collected. The trace data may be exported through shared memory and stored for further analysis by trace analysis module 230.

Trace analysis module 230 may analyze the trace data collected by tracing module 220 in order to identify content data regions and metadata memory regions. Different regions of memory can be classified based on address ranges in process's memory map. For example, stack, block starting symbol (BSS) or data sections in object files, and heap all sit in isolated regions. Heap memory may include memory used to server ephemeral requests (e.g., data structures to hold session information), memory used throughout the life cycle of a process (e.g., data structures to hold statistics counters), and the like. In particular, trace analysis module 230 may identify metadata regions that is used as a table of contents to access content, and the content itself, which is memory that holds large amounts of data that is largely stationary after materialization (e.g., memory having below a threshold number of read/write accesses during execution of the process).

In order to identify the metadata regions, the preconfigured tasks that are performed during the trace may include a list iterator that goes through a loop of index values. As a result, the resulting trace data may include repeated clusters of memory access instructions visiting alternating addresses, which can be identified by trace analysis module 230. Since traces belonging to the same task exhibit the same loop structure with matching addresses, such regions can be identified as metadata regions. However, patterns that appear more than once may be discarded as metadata candidates. Trace analysis module 230 may identify a metadata region that includes pointers to content when a pattern indicates single level redirections to other contiguous areas in memory. There may be multiple candidates for pointer regions, in which case an actual pointer region can be identified by the presence of a cluster of virtual addresses that within a predefined threshold of memory addresses of each other and that are associated with accesses to another area of memory (i.e., a content region). By varying the process's accesses to these pointers during the trace (e.g., using different tasks or indices) and monitoring which addresses are accessed, trace analysis module 230 can identify the boundaries of the content region.

Migration module 240 modifies execution of a process by causing the content region to be migrated to remote memory and by patching the process to cause the process to access the remote memory instead of local memory when accessing content. Initially, migration module 240 may suspend the process or check to determine that the process is not executing. Next, migration module 240 may copy the identified content region to memory of a remote node. In order to ensure that the migrated data is page-aligned (i.e., full memory pages rather than partial pages), a portion of the content region is migrated that aligns to page boundaries. The portion may be a subset that is a predetermined ratio of the content region (e.g., 95% of the content region, 99% of the content region, etc.) or the portion can be a maximum amount of the content region less any pages in which the boundaries of the content region are contained. Migration module 240 may patch the process to replace the migrated content region with remote logic that redirects access operations to the portion of content data to instead access the copy of the content data portion in the remote memory.

In some embodiments, migration module 240 may perform operations to determine that the content region can be migrated without disrupting execution of the process. Migration module 240 may check if any content access functions depend on shared libraries and/or system calls that assume that the content is local (i.e., functions that require local content). In some embodiments, if trace analysis module 230 cannot determine that there is no access to the content region beyond the range of the content access function, then the migration may not occur. If the migration can occur, migration module 240 replaces the migrated data with a forwarding stub that sends requests to the remote node through the operating system. The remote node may also include a daemon process that is configured by the remote node's operating system with logic to handle requests from the process for access to the migrated copy of content data.

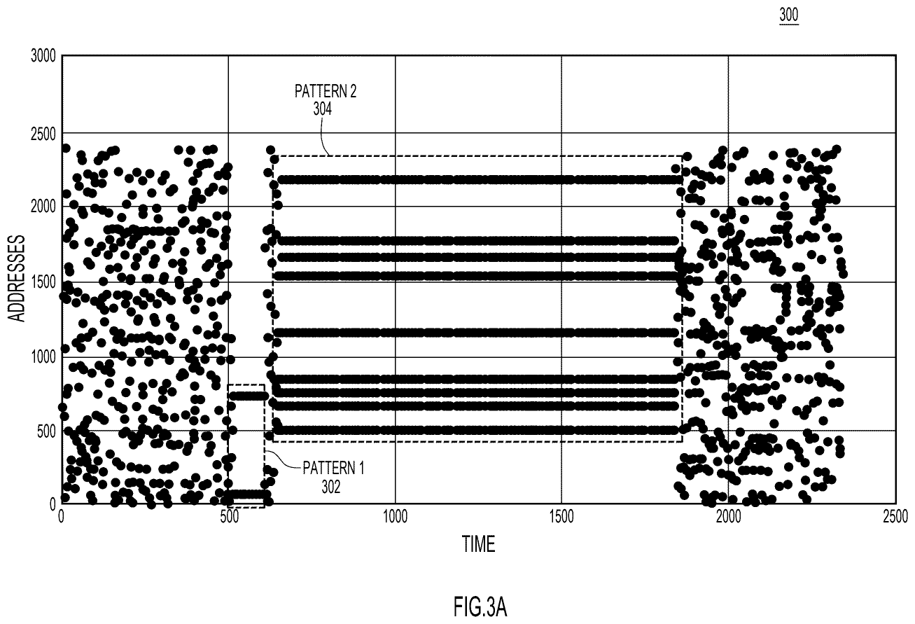

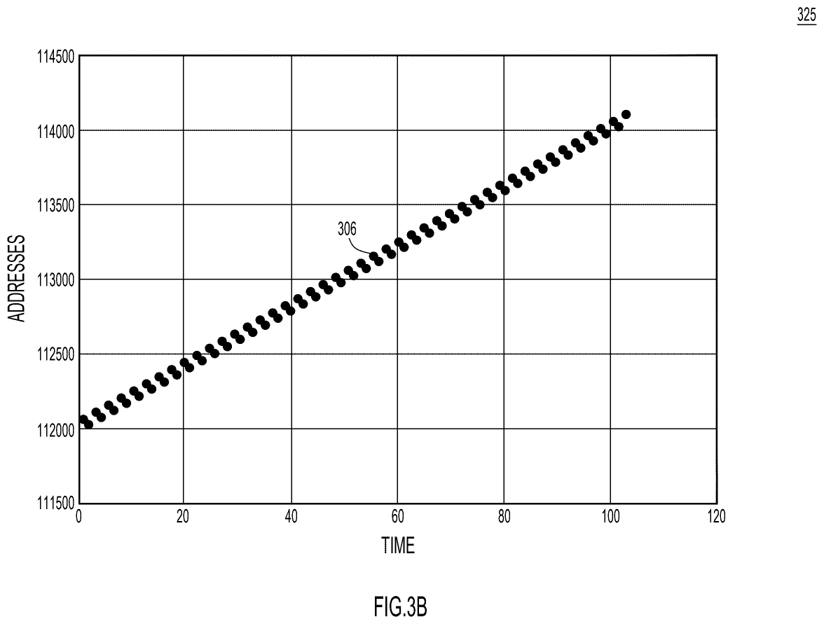

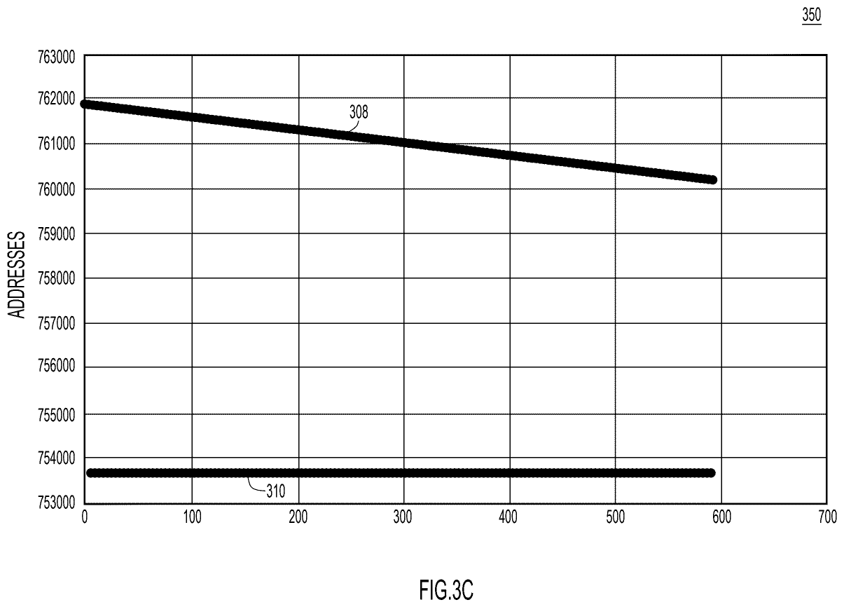

FIG. 3A-3C are graphs of memory-access instructions/memory-address patterns according to an embodiment of the present invention. With reference to FIG. 3A, graph 300 illustrates memory access instruction patterns captured during tracing of a process plotted according to axes of time and instructions that perform memory access tagged by random numbers. While some of the accesses appear to be random, a first pattern 302 (“pattern 1”) and a second pattern 304 (“pattern 2”) are present. These patterns indicate that a set of memory access instructions is executed repeatedly over a span of time, and usually those are memory access instructions inside loops. The trace data of graph 300 may be generated by instructing the process to fetch a particular element from a list or array (e.g., “lindex 100,000”, which fetches the 100,000th element).

With reference now to FIG. 3B, graph 325 illustrates memory address accesses over time with respect to the first pattern 302 of FIG. 3A. Thus, pattern 306 illustrates a loop over metadata. Likewise, graph 350 of FIG. 3C includes pattern 308 and pattern 310, which are memory address accesses over time with respect to the second pattern 304 of FIG. 3A and also indicate looping accesses. Thus, these patterns 306, 308, and 310 may be candidates for metadata that contains pointers to a content region.

The two patterns in FIG. 3A are derived from observing the execution of instructions that access memory: visited memory access instructions are recorded with their randomly assigned number tags. After identifying patterns like pattern 302 and pattern 304 in FIG. 3A, those memory access instructions are augmented with the instructions to track memory address to collect memory address traces that are illustrated in FIGS. 3B and 3C.

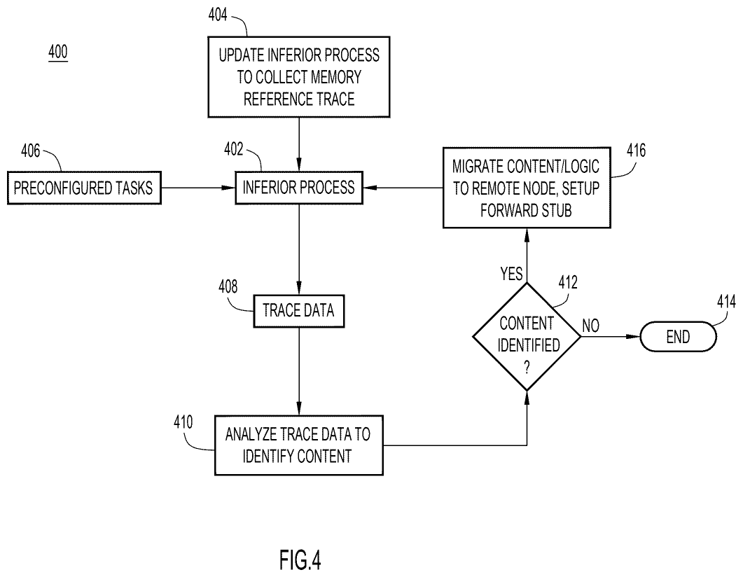

FIG. 4 is a flowchart of a method 400 for performing a trace-based analysis and memory migration according to an embodiment of the present invention.

Initially, an inferior process 402 is selected that will be modified in order to enable the inferior process 402 to utilize memory inception techniques. At operation 404, the inferior process is updated to collected memory reference trace data. A function may be inserted in the inferior process 402 that causes trace data to be collected when other functions are called. The trace data 408 is generated by executing preconfigured tasks 406 using the modified inferior process 402. These tasks may include instructions to access particular elements in an array, such as the first element, the second element, the 100,000th element, and the like.

At operation 410, the trace data 408 is analyzed to identify a content region. The content region may be identified by first identifying a metadata region based on looping memory accesses, and determining that the metadata region includes pointers to a content region. By varying inputs, which are included in the preconfigured tasks 406, the boundaries of the content region can be identified.

Operation 412 determines whether a content region is identified. In some embodiments, a content region is only identified if there is one possible content region. Additionally or alternatively, a content region may be identified as migratable only if the process does not contain any functions or calls that assume local access to the content.

If a content region is not identified, or is identified but cannot be migrated, then method 400 terminates at operation 414. If a content region is identified at operation 412, the content region is migrated at operation 416 and logic is inserted in the inferior process 402 to access the migrated copy of the content, along with logic in the remote node to handle requests to access the migrated copy.

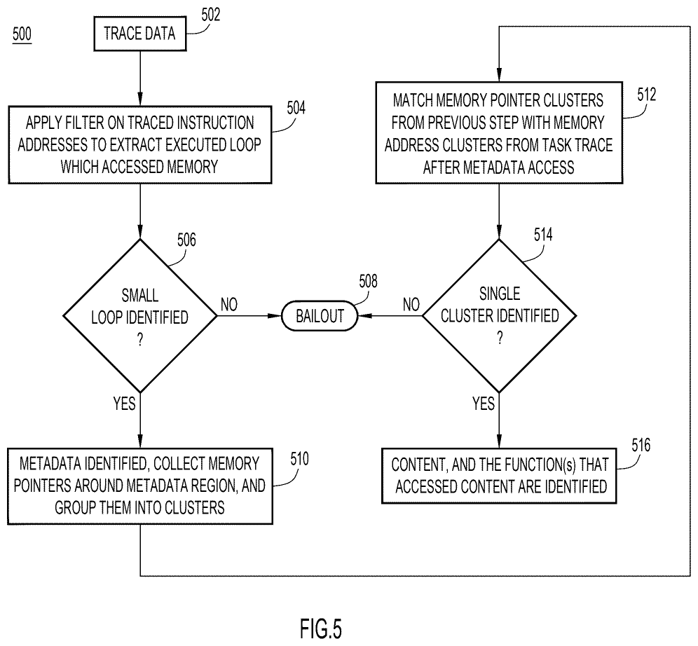

FIG. 5 is a flowchart of a method 500 for identifying a content region according to an embodiment of the present invention. Initially, trace data 502 is collected for analysis. At operation 504, a filter is applied on the traced instruction addresses to extract an executed loop in which memory addresses are repeatedly accessed according to a pattern. One or more loops may be identified, which correspond to candidates for metadata regions, at operation 506. However, if no loops are identified, then method 500 terminates at operation 508.

Each loop may be analyzed to identify a metadata region containing pointers at operation 510. Memory pointers around the metadata region are collected and grouped into clusters in which groups of pointers fall within a threshold distance of each other in terms of memory addresses.

At operation 512, the identified clusters of memory pointers are matched with memory address clusters from the task trace that occur at points in time after metadata access. These latter clusters may be candidates for the content region of the process. Thus, each pointer cluster can be evaluated to determine whether a matching content region cluster of memory accesses occurs within a threshold amount of time after the pointer cluster accesses.

Operation 514 determines whether a single matching cluster is identified. If there is no identified cluster, or if there are multiple matching clusters, then method 500 terminates at operation 508.

If there is a single matching cluster, then that cluster is identified as a content region at operation 516. The functions that access the content region may be identified. In some embodiments, each function is analyzed to determine whether it requires local memory access.

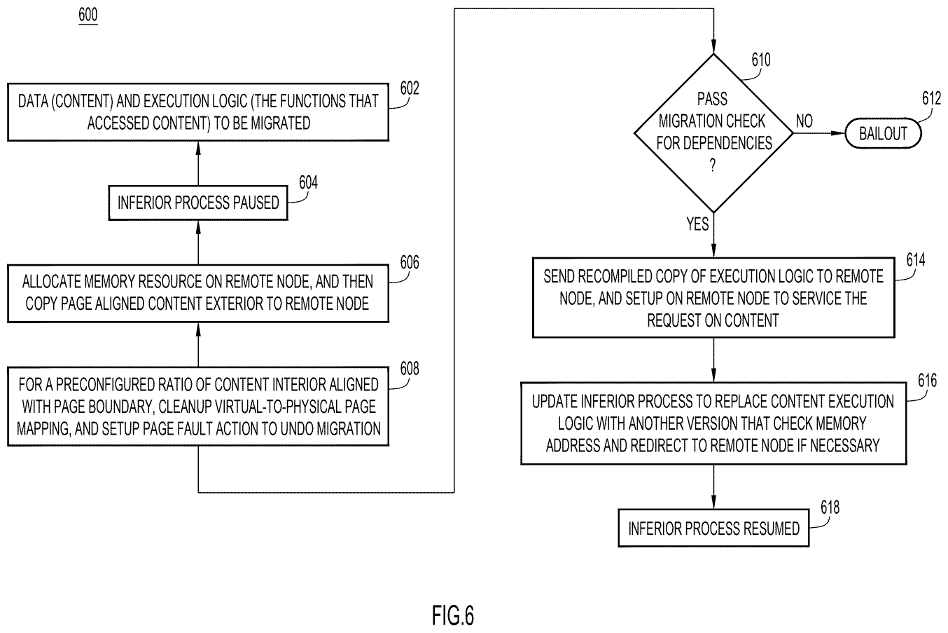

FIG. 6 is a flowchart of a method 600 for migrating a content region according to an embodiment of the present invention.

At operation 602, data corresponding to the content memory region and execution logic including functions that access the content region are received. This data can be provided as a result of method 500, which is depicted and described with reference to FIG. 5. In order to modify the inferior process, the process is paused at operation 604.

Once the inferior process is paused, memory resources are allocated on the remote node, and a page-aligned copy of the content is provided to the remote note at operation 606. The remote node may be analyzed to ensure that there is sufficient memory to support the copy of the content data. In some embodiments, two or more remote nodes may be utilized to store the content data, which can be spread across the nodes.

At operation 608, a preconfigured ratio (i.e., subset) of the content data is selected that is aligned to page boundaries, the virtual-to-physical page mappings are cleaned up, and page fault actions are set up so that the migration can be undone later. The portion of content data that is page-aligned may be a predetermined ratio of the content (e.g., 95%) that is rounded up or down to the nearest page boundary. The page mappings are cleaned up so that mappings may be provided that point to the migrated content data.

Operation 610 determines whether a migration check for dependencies is passed. This check may determine whether there are any dependencies that require the content data to be local. If there are such dependencies, then method 600 terminates at operation 612.

If the check is passed at operation 610, a recompiled copy of the execution logic is sent to the remote node and the remote node is set up to service requests for content data at operation 614. A daemon may be configured by the operating system of the remote node to handle content data requests.

At operation 616, the inferior process is updated to replace the content execution logic with a version that checks memory addresses and redirects requests to the remote node if necessary. If a request is requesting content data that falls within the migrated region, then the request is redirected. The content memory region that is migrated from the inferior process is deleted and/or replaced with this logic, reducing the memory requirements of the local host of the inferior process. Once this is completed, the inferior process is resumed at operation 618.

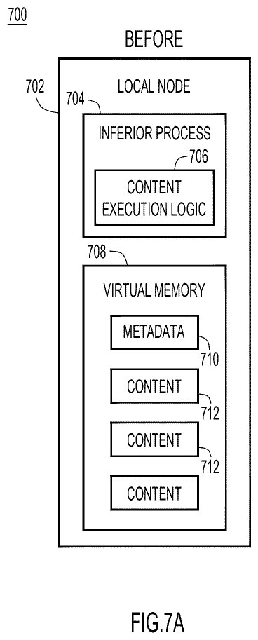

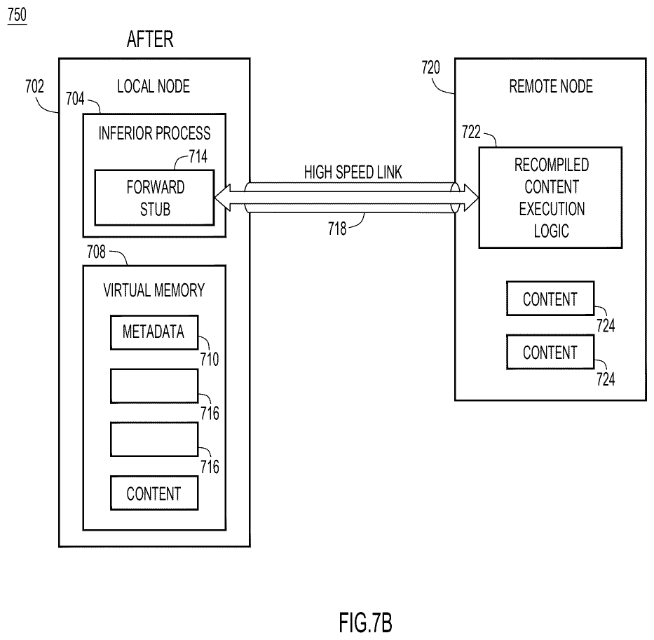

FIG. 7A is a block diagram of a processing environment 700 before migration of a content region according to an embodiment of the present invention. As depicted, processing environment 700 includes a local node 702 hosting an inferior process 704 that utilizes virtual memory 708. The inferior process 704 includes content execution logic 706 that includes one or more functions that require access to the content data. Virtual memory 708 includes a metadata region 710 and content regions 712 that are each identified according to the embodiments presented herein.

With reference to FIG. 7B, a block diagram is provided of a processing environment 750 after migration of a content region according to an embodiment of the present invention. Processing environment 750 includes the local node 702 of processing environment 700. However, the inferior process 704 has been modified to insert a forward stub 714 that forwards requests for migrated content data to the remote node 720. The virtual memory 708 includes metadata 710 region; however, a portion 716 of the content (e.g., the content regions 712 shown in FIG. 7A) is no longer present at the local node 702.

The local node 702 is connected to the remote node 720 via a high speed link 718. The high speed link 718 may be an interconnect such as an InfiniBand connection, an ethernet fabric, a Peripheral Component Interconnect Express (PCIe) fabric, a Compute Express Link, an Open Coherent Accelerator Processor Interface (OpenCAPI) link, and the like. The remote node 720 may include any computing system or device; in one embodiment, the remote node 720 is a smart Network Interface Card (NIC) that is equipped with one or more Field Programmable Gate Arrays (FPGAs) and persistent memory (PMEM).

After migration, the remote node 720 is configured with recompiled content execution logic 722, which handles requests for content that are redirected and provided by the forward stub 714. The copy of the portion of content data 724 resides in memory of the remote node 720 and may be utilized for responses to requests for content data by the inferior process 704.

It will be appreciated that the embodiments described above and illustrated in the drawings represent only a few of the many ways of implementing embodiments for remote memory migration using trace-based data classification.

The environment of the present invention embodiments may include any number of computer or other processing systems (e.g., any computing device, computing service, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., application code 200, application(s) 210, tracing module 220, trace analysis module 230, migration module 240, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, distributed computing, and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the computing system. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., application data, data processed by application(s) 210, tracing module 220, trace analysis module 230, migration module 240, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The application data, data processed application(s) 210, tracing module 220, trace analysis module 230, migration module 240, and/or any other data may include any information arranged in any fashion, and may be configurable based on rules or other criteria to provide desired information to a user.

The present invention embodiments are not limited to the specific tasks or algorithms described above, but may be utilized for any tasks involving automatically adapting processes for memory inception techniques.

The data may include any format of storing data and may include any data descriptive of databases, including metadata and indexes thereof. The data may be obtained via any techniques, and may be accessed over a network, fetched from local storage, provided via user input, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
performing a trace on a process that is executing one or more preconfigured tasks to collect trace data comprising memory access addresses of the process and function calls of the process;
analyzing the trace data to identify one or more metadata memory regions based on frequent memory accesses and a content memory region based on infrequent memory accesses during the trace;
determining that a portion of content addresses of the content memory region can be migrated to a remote memory without disrupting execution of the process;
migrating the portion of content addresses to the remote memory;
patching the process to insert remote logic that redirects access operations to the portion of the content addresses to the migrated portion of content addresses in the remote memory; and
executing the process.

2. The computer-implemented method of claim 1, wherein determining that the portion of content addresses of the content memory region can be migrated to the remote memory comprises:
verifying that each function call does not include an access function to the content memory region that depends on a library or system call that requires the portion of content addresses to be local.

3. The computer-implemented method of claim 1, wherein the portion of content addresses comprises a subset of a total content addresses of the content memory region.

4. The computer-implemented method of claim 1, wherein the portion of content addresses comprises page-aligned data.

5. The computer-implemented method of claim 1, wherein the process is executed on a first node of a rack, and wherein the remote memory is associated with a second node of the rack.

6. The computer-implemented method of claim 1, wherein identifying the content memory region comprises identifying boundaries of the content memory region by executing an index-based retrieval operation with varying input indices and obtaining addresses of data fetched by the index-based retrieval operation.

7. The computer-implemented method of claim 1, wherein the process is an in-memory database application.

8. A computer system comprising:
a processor set;
one or more computer-readable storage media; and
program instructions stored on the one or more computer-readable storage media to cause the processor set to perform operations comprising:
performing a trace on a process that is executing one or more preconfigured tasks to collect trace data comprising memory access addresses of the process and function calls of the process;
analyzing the trace data to identify one or more metadata memory regions based on frequent memory accesses and a content memory region based on infrequent memory accesses during the trace;
determining that a portion of content addresses of the content memory region can be migrated to a remote memory without disrupting execution of the process;
migrating the portion of content addresses to the remote memory;
patching the process to insert remote logic that redirects access operations to the portion of the content addresses to the migrated portion of content addresses in the remote memory; and
executing the process.

9. The computer system of claim 8, wherein determining that the portion of content addresses of the content memory region can be migrated to the remote memory comprises:
verifying that each function call does not include an access function to the content memory region that depends on a library or system call that requires the portion of content addresses to be local.

10. The computer system of claim 8, wherein the portion of content addresses comprises a subset of a total content addresses of the content memory region.

11. The computer system of claim 8, wherein the portion of content addresses comprises page-aligned data.

12. The computer system of claim 8, wherein the process is executed on a first node of a rack, and wherein the remote memory is associated with a second node of the rack.

13. The computer system of claim 8, wherein identifying the content memory region comprises identifying boundaries of the content memory region by executing an index-based retrieval operation with varying input indices and obtaining addresses of data fetched by the index-based retrieval operation.

14. The computer system of claim 8, wherein the process is an in-memory database application.

15. A computer program product comprising:
one or more computer-readable storage media; and
program instructions stored on the one or more computer-readable storage media to perform operations comprising:
performing a trace on a process that is executing one or more preconfigured tasks to collect trace data comprising memory access addresses of the process and function calls of the process;
analyzing the trace data to identify one or more metadata memory regions based on frequent memory accesses and a content memory region based on infrequent memory accesses during the trace;
determining that a portion of content addresses of the content memory region can be migrated to a remote memory without disrupting execution of the process;
migrating the portion of content addresses to the remote memory;
patching the process to insert remote logic that redirects access operations to the portion of the content addresses to the migrated portion of content addresses in the remote memory; and
executing the process.

16. The computer program product of claim 15, wherein determining that the portion of content addresses of the content memory region can be migrated to the remote memory comprises:
verifying that each function call does not include an access function to the content memory region that depends on a library or system call that requires the portion of content addresses to be local.

17. The computer program product of claim 15, wherein the portion of content addresses comprises a subset of a total content addresses of the content memory region.

18. The computer program product of claim 15, wherein the portion of content addresses comprises page-aligned data.

19. The computer program product of claim 15, wherein the process is executed on a first node of a rack, and wherein the remote memory is associated with a second node of the rack.

20. The computer program product of claim 15, wherein identifying the content memory region comprises identifying boundaries of the content memory region by executing an index-based retrieval operation with varying input indices and obtaining addresses of data fetched by the index-based retrieval operation.
